(19) United States
(12) Patent Application Publication
(10) Pub. No.: US 2018/0085927 A1
(43) Pub. Date: Mar. 29, 2018

(54) OPTIMIZING A LAYOUT OF OBJECTS IN A SPACE

(71) Applicant: International Business Machines Corporation, Armonk, NY (US)

(72) Inventors: Reena Kapoor, Essendon (AU); Lenin Mehedy, Doncaster East (AU); Hidemasa Muta, Caulfield South (AU)

(21) Appl. No.: 15/278,753

(22) Filed: Sep. 28, 2016

(51) Int. Cl. B25J 9/16; G05D 1/02; A47L 11/24

(52) U.S. Cl. CPC B25J 9/1697; B25J 9/1664; G05D 1/0246; A47L 2201/04; A47L 11/24; G05D 2201/0203; G05D 1/0219

(57) ABSTRACT

A method for optimizing a layout of a plurality of items in a space comprises receiving one or more conditions related to the layout, analyzing the one or more conditions to determine one or more proposed optimized layouts incorporating the one or more conditions, generating one or more virtual images of the one or more proposed optimized layouts, and providing the one or more virtual images to be displayed for a user.

### BACKGROUND

Robot vacuum cleaners are becoming popular and widely adopted. Such robots move autonomously and may have the ability to create virtual landmarks that are within a dwelling for easier navigation throughout various rooms, and for returning to a charging station when needed. For example, some robot vacuum cleaners develop a cleaning pattern using a plurality of sensors, which works around obstacles in a room. During a cleaning process, a robot cleaner may create landmarks in a map to keep track of where it is, and where it has already been for precise navigation and cleaning. For example, a robot cleaner may use landmarks within a room to triangulate its position in the room.

A robot cleaner may use a camera to provide it with a panoramic view of its surroundings, which the robot cleaner can use to establish a cleaning pattern. The camera can provide a continuously updated view of the cleaner's environment. The camera, when used with localization and mapping software, can create a 360° view of a room.

At times, the robot cleaners cannot move efficiently in a room because of the furniture layout or other obstacles which may impede their paths.

### SUMMARY

According to an exemplary embodiment of the present invention, a method for optimizing a layout of a plurality of items in a space comprises receiving one or more conditions related to the layout, analyzing the one or more conditions to determine one or more proposed optimized layouts incorporating the one or more conditions, generating one or more virtual images of the one or more proposed optimized layouts, and providing the one or more virtual images to be displayed for a user.

According to an exemplary embodiment of the present invention, a system for optimizing a layout of a plurality of items in a space comprises a memory and at least one processor coupled to the memory, wherein the at least one processor is configured to receive one or more conditions related to the layout, analyze the one or more conditions to determine one or more proposed optimized layouts incorporating the one or more conditions, generate one or more virtual images of the one or more proposed optimized layouts, and provide the one or more virtual images to be displayed for a user.

According to an exemplary embodiment of the present invention, a computer program product for optimizing a layout of a plurality of items in a space comprises a computer readable storage medium having program instructions embodied therewith, the program instructions executable by a processor to cause the processor to perform a method comprising receiving one or more conditions related to the layout, analyzing the one or more conditions to determine one or more proposed optimized layouts incorporating the one or more conditions, generating one or more virtual images of the one or more proposed optimized layouts, and providing the one or more virtual images to be displayed for a user.

### BRIEF DESCRIPTION OF THE DRAWINGS

FIG. 1A is a block diagram illustrating operation of an optimization component, according to an embodiment of the invention.

FIG. 1B is a block diagram illustrating a robot cleaning device including the optimization component, according to an embodiment of the invention.

FIG. 2 illustrates the structure of a room and an optimal path for the movement of a cleaning device, according to an embodiment of the invention.

FIG. 3 illustrates a first layout of items in the room, according to an embodiment of the invention.

FIG. 4 illustrates a second layout of items in the room, according to an embodiment of the invention.

FIG. 5 illustrates a third layout of items in the room, according to an embodiment of the invention.

FIG. 6 illustrates a fourth layout of items in the room, according to an embodiment of the invention.

FIG. 7 illustrates a fifth layout of items in the room, according to an embodiment of the invention.

FIG. 8 illustrates a sixth layout of items in the room, according to an embodiment of the invention.

FIG. 9 is a flow diagram of a process for optimizing a layout of a plurality of items in a space, according to an exemplary embodiment of the invention.

FIG. 10 illustrates a computer system in accordance with which one or more components/steps of the techniques of the invention may be implemented, according to an exemplary embodiment of the invention.

FIG. 11 depicts a cloud computing environment, according to an exemplary embodiment of the present invention.

FIG. 12 depicts abstraction model layers, according to an exemplary embodiment of the invention.

### DETAILED DESCRIPTION

In illustrative embodiments, systems and techniques are provided for recommending an optimized furniture layout. More particularly, illustrative embodiments provide systems and techniques which improve navigation efficiency of a robot vacuum cleaner by optimizing the layout of items, such as, but not limited to, furniture, electronic equipment, and plants, in a room. Additionally, the embodiments of the present invention can provide systems and techniques for recommending an optimized item layout, which reduces health, safety and movement hazards, and which may be used by, for example, individuals that require accommodations that consider such hazards.

In accordance with an embodiment of the present invention, a robot vacuum cleaner, or any network connected device, such as a smart-phone, recommends an optimized item layout, which can improve navigation efficiency of the robot vacuum cleaner and/or reduce health, safety and movement hazards in a specific area of operation.

The embodiments of the present invention are not necessarily limited to a robot vacuum cleaner, and may include other home appliances, or devices that can be equipped with different sensors, cameras, etc., in order to collect necessary data to optimize a layout. Such a system can be for use in, for example, home, office, store, warehouse or any other indoor/outdoor environment where a layout of items can be optimized for improving navigation efficiency of a device and/or preventing health, safety and movement hazards. Accordingly, in addition to navigation efficiency, a proposed system can be programmed to consider other well-being objectives in order to identify potential optimal room item layouts.

In accordance with an embodiment of the present invention, a system collects images and various other sensor information and uses the collected information to build an item layout model for a given environment. The system can optimize the layout based on various objective conditions and/or constraints, and provide a user with one or more optimal layouts that the user may consider. The optimal layouts may be ranked for the user based on how well the layouts meet any proposed objectives. Examples of objectives to be met by an optimized layout include, but are not necessarily limited to: a) allowing easier cleaning by automated home appliances, such as vacuum cleaners; b) increasing open space for easier movement of people and/or pets; c) optimizing distances from windows and/or other heat, moisture or light sources to improve furniture life span; d) reducing navigation hazards; and e) optimizing airflow in a particular environment, improving heating and cooling performance.

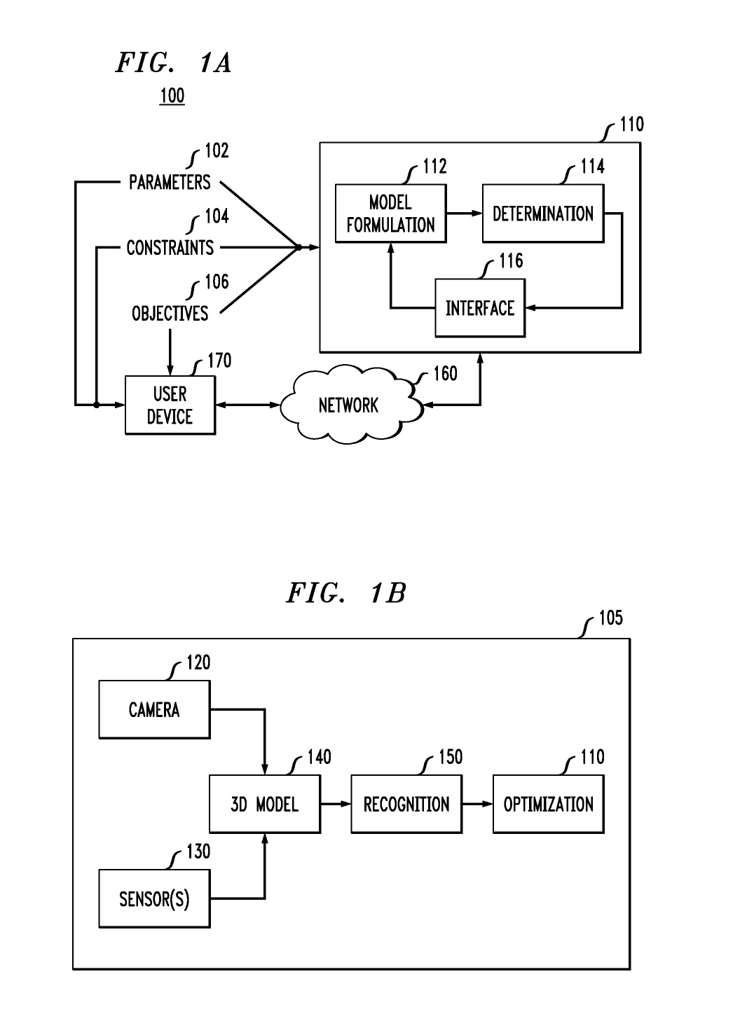

FIG. 1A is a block diagram 100 illustrating operation of an optimization component 110, according to an exemplary embodiment of the present invention. FIG. 1B is a block diagram illustrating a robot cleaning device including the optimization component, according to an exemplary embodiment of the invention. As shown in FIGS. 1A and 1B by lines and/or arrows, components are operatively connected to each other via, for example, physical connections, such as wired and/or direct electrical contact connections, and/or wireless connections, such as, for example, WiFi, BLUETOOTH, IEEE 802.11, and/or networks, including but not limited to, a local area network (LAN), wide area network (WAN), cellular network, ad hoc networks, WANET, satellite network or the Internet.

Referring to FIG. 1A, an optimization component 110 provides a number of optimal layouts to a user depending on parameter(s) 102, constraint(s) 104 and objective(s) 106 inputted to or received by the optimization component 110. For example, parameters 102, constraints 104 and objectives 106 can be inputted by the user or be pre-programmed into the optimization component 110. The parameters 102, constraints 104 and objectives 106 can be inputted directly to the optimization component via an interface 116, or via a user device 170, such as, for example, a portable device like a smart phone, tablet, and/or personal digital assistant (PDA), which is operatively connected to the optimization component 110 via a network 160, so that parameters 102, constraints 104 and/or objectives 106 can be transmitted to the optimization component 110 via the network 160 and interface 116. The network 160 can include, but is not necessarily limited to, a local area network (LAN), wide area network (WAN), cellular network, ad hoc networks, WANET, satellite network or the Internet.

The optimization component 110 includes a model formulation engine 112, which formulates an optimization model based on the parameters 102, constraints 104, and/or objectives 106. For example, based on the information and requirements provided by the parameters 102, constraints 104 and objectives 106, the model formulation engine 112 creates an optimization model using a linear program and/or a mixed integer program. Then, a determination module 114 develops one or more optimal layouts based on the model, and generates virtual views of the optimal layouts (e.g., virtual two-dimensional top views or three-dimensional views of a floor plan) which are presented to a user via an interface module 116. The user can then select a layout from the received virtual optimal layouts. In accordance with an embodiment of the present invention, the optimal layouts can be transmitted to the user via a user device 170 in communication with the optimization component 110 over network 160. Alternatively, the user can view the generated virtual optimal layouts directly on a robot cleaning device 105 or other device including the optimization component 110.

A list of parameters and their values can be provided by the user, sensing devices and/or domain experts. For example, the parameters 102 can include, but are not necessarily limited to: 1) furniture (or other items) in a room and their initial positions; 2) general minimum distance required between each wall and each piece of furniture for easy navigation; 3) general required distance between individual pieces of furniture; 4) general required distance of some or all of the furniture from windows and doors. In accordance with an embodiment of the present invention, the optimization component 110 will ask the user, via the interface module 116, to choose the parameters from a list of possible parameters and will ask for the values of the chosen parameters. The value of the remaining parameters will automatically be taken as zero by the tool. According to another embodiment, as explained further below, furniture (or other items) in a room and their initial positions can be detected and calculated by components of a robot cleaner 105, such as, for example a camera 120, other sensors 130, a three-dimensional modeling module 140 and a recognition module 150, which can transmit the determined initial layout information to the optimization component 110.

In accordance with an embodiment of the present invention, user specific needs and requirements will define the constraints 104 for the optimization component 110. The subject of a constraint can overlap with that of a parameter. However, the parameter is of a general nature, determined by, for example, domain experts, while the constraint is specific to a particular user's request or situation, and may override a parameter. For example, some of the user specific constraints may include, but are not limited to: 1) a requirement for particular placement of a piece of furniture, such as, that a specific piece of furniture not be placed opposite to a window in the room (e.g., requiring that a television sit under a window in a room so that the effect of sunlight on picture quality is minimized) or that an item or a piece of furniture be placed under a window in direct sunlight; 2) a specific requirement that furniture be at a minimum distance of from a wall in a room (e.g., to provide for easier navigation of a robot cleaner); and/or 3) requiring that pieces of furniture be at a minimum distance from each other in the room (e.g., to provide for easier navigation of a robot cleaner). In accordance with an embodiment of the present invention, the optimization component 110 asks a user to choose constraints from a list of possible constraints. The remaining constraints will automatically be switched off by the optimization component 110.

Other than user specific needs, there may be some global constraints on a layout of the furniture. By way of non-limiting example, some global constraints may include: 1) a center table sitting with the main sitting arrangement in a living room within some specific range of the main sitting arrangement; 2) a dining table and chairs sitting together; 3) a television not at the back of a main sitting arrangement in a room; 4) no furniture blocking an entrance door or any other door in a room; and/or 5) no furniture blocking any window in the room.

In accordance with an embodiment of the present invention, a user will choose objective(s) 106 from a given list of possible objectives. The list will attempt to cover all possible objectives; however the list can be updated if new objectives are determined. Some examples of the objectives include, but are not limited to: 1) obtaining a layout of furniture in a room so that a robot vacuum cleaner can move along its path requiring movement of any furniture after an initial cleaning; 2) minimizing the movement of furniture from its initial positions; 3) minimizing health issues or chances of hazards due to the layout of the furniture in the room (e.g., requiring that the furniture layout not block sunlight and fresh air in a room or requiring ample space between furniture pieces to permit safe movement; 4) minimizing the turns that a robot vacuum cleaner is required to take for cleaning a room in order to save energy and time consumed by the vacuum when cleaning the room; 5) maximizing the space/usage of the room; 6) maximizing the ease of moving around the room; and/or 7) maximizing the play space for children.

In accordance with an embodiment of the present invention, the optimization component 110 receives values of parameters 102, constraints 104, and/or objectives 106 that should be satisfied by the furniture layout. Parameters 102 in a stored list that are not relevant or selected will automatically be set to zero by the model formulation module 112, and the constraints 104 and objectives 106 that are not required by a user will automatically be set to zero and/or will not be passed to the model formulation module 112. Based on the parameters 102, constraints 104, and/or objectives 106 received by the model formulation module 112, the model formulation module 112 will create and optimization model by using a linear program or mixed integer program, and the determination module 114 will determine and rank optimal layouts provided by the optimization model, which can be presented to a user via interface 116 for selection of an optimal layout.

Referring to FIG. 1B, a robot cleaning device 105, such as a robot vacuum cleaner includes a camera 120, such as, for example, a fish eye camera. According to an embodiment of the present invention, the robot cleaning device 105, using the camera 120, will take numerous fish eye view pictures of the room at different positions while cleaning. After cleaning, the robot cleaning device 105 will process the fish eye view pictures on itself using a three-dimensional (3D) model component 140, or on a network connected system (e.g. cloud service), to build a virtual 3D point cloud model of the room using, for example, the following steps: 1) extract multiple rectilinear views from the fish eye view pictures; 2) between whole rectilinear views at multiple locations in the room, find corresponding key-points to relatively localize each view; 3) generate a virtual 3D point cloud model of the room by applying structure from motion (SfM) techniques. Alternatively, the 3D modeling of the room may also be done using simultaneous localization and mapping (SLAM) techniques. The robot cleaning device 105 can include other sensors 130, such as, for example, motion sensors to differentiate between stationary and moving objects in a room, and light and heat sensors to detect sources of light and heat in a room, which may factor into the optimal layout based on considerations of room lighting and/or distance from heat sources.

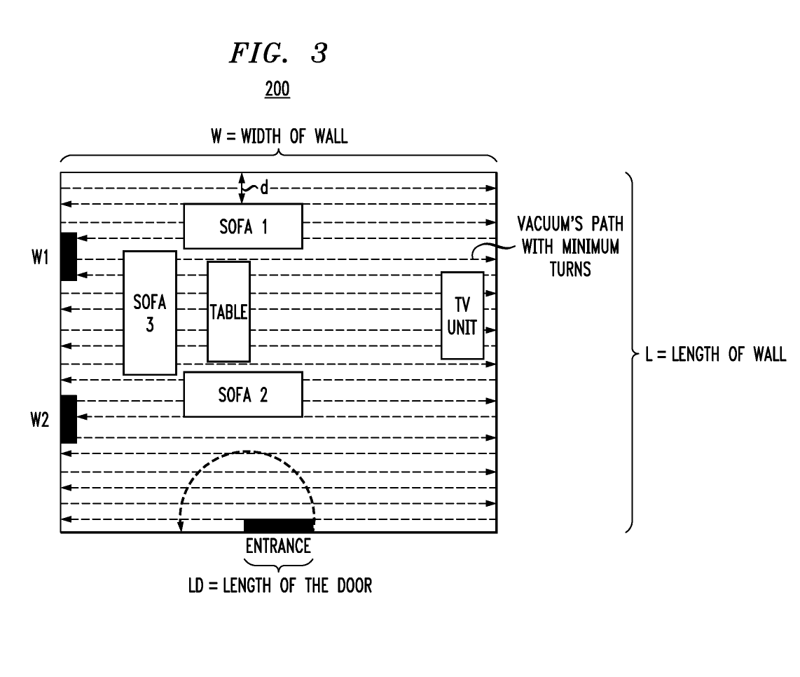

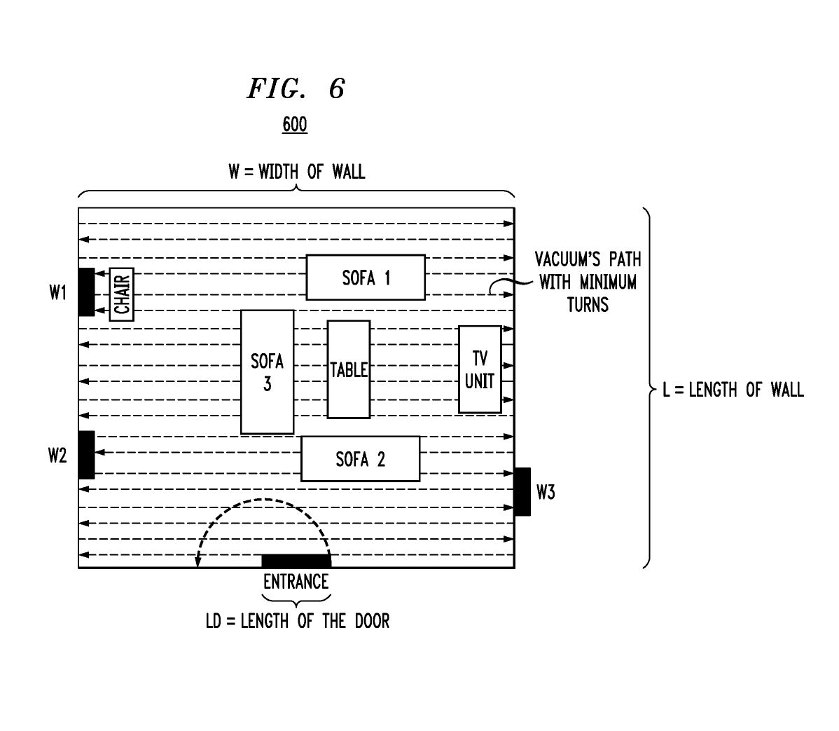

According to an embodiment of the present invention, a recognition module 150 of the robot cleaning device 105 will detect objects, for example furniture, in the room from the 3D point cloud using the following steps: 1) classify point clusters to floor, walls, and other objects by comparing the height of the points; 2) recognize, for example, objects such as a table, chair, desk, bed, toy, and so on in the virtual object point clouds by 3D object recognition; 3) extract top view two-dimensional (2D) coordinates of each object, calculate the width and length of each object, and generate a virtual top view of a room, such as the initial layouts shown in FIGS. 3 and 6, including a floor plan of the room with a layout, including the relative size and location of the items (e.g., furniture) in the room.

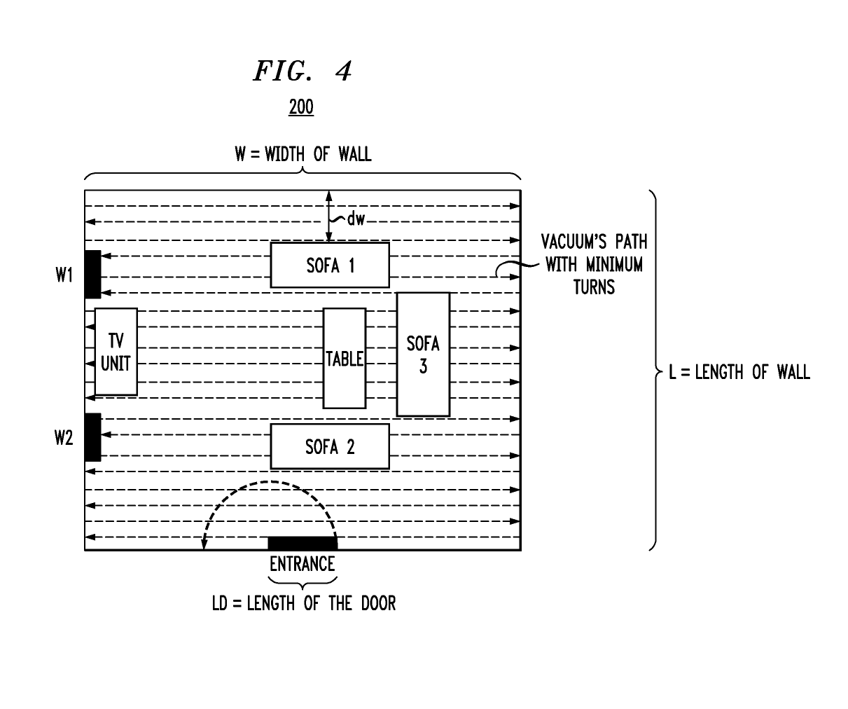

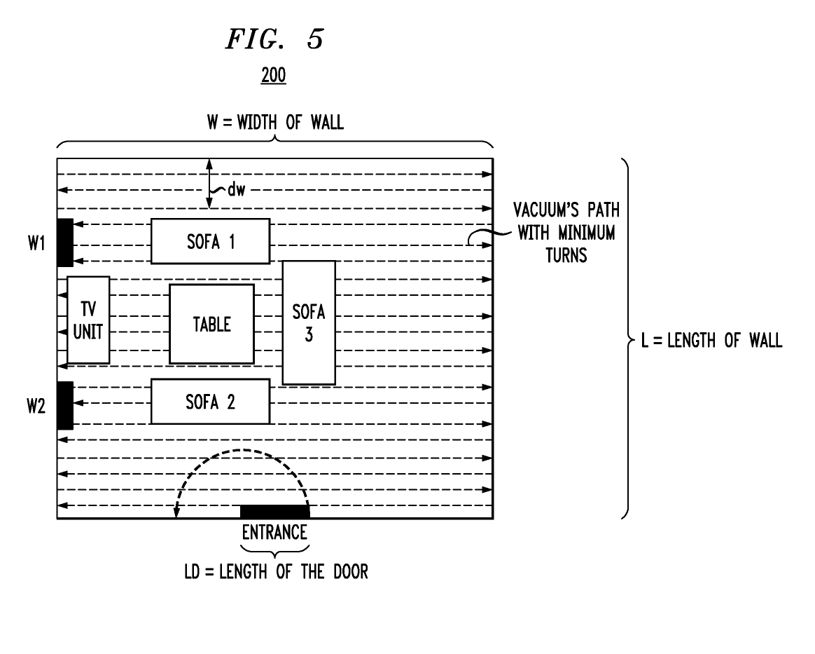

The optimization component 110 of the robot cleaning device 105 will then optimize object layout based on various objectives and constraints. As noted above, examples of objectives may include effective cleaning with minimum movement, ergonomic and convenient setups for humans, and good traffic lines for humans and animals. Examples of constraints may include such items as room dimensions, window and door locations, and furniture relations and required associations. For example, a sofa should not be behind a television, dining chairs need to be around a table, etc. The optimization component then generates virtual proposed layouts for viewing by a user, and transmits the identified improved proposed layouts to one or more users for consideration through various mediums, such as, but not necessarily limited to, smart-phones, tablets, and web pages, the proposed layouts including, for example, virtual top views of optimal layouts as shown in FIGS. 4, 5, 7 and 8. Acceptance of a layout proposal or feedback of users are collected to further improve the recommendations of the determination module 114 by using, for example, machine learning techniques. In addition, previously calculated layouts, knowledge from various homes/environments, and multiple users' feedback about layout recommendations can be shared between appliances via, for example, network communication, and used along with machine learning techniques for improving the recommendations of the determination module 114.

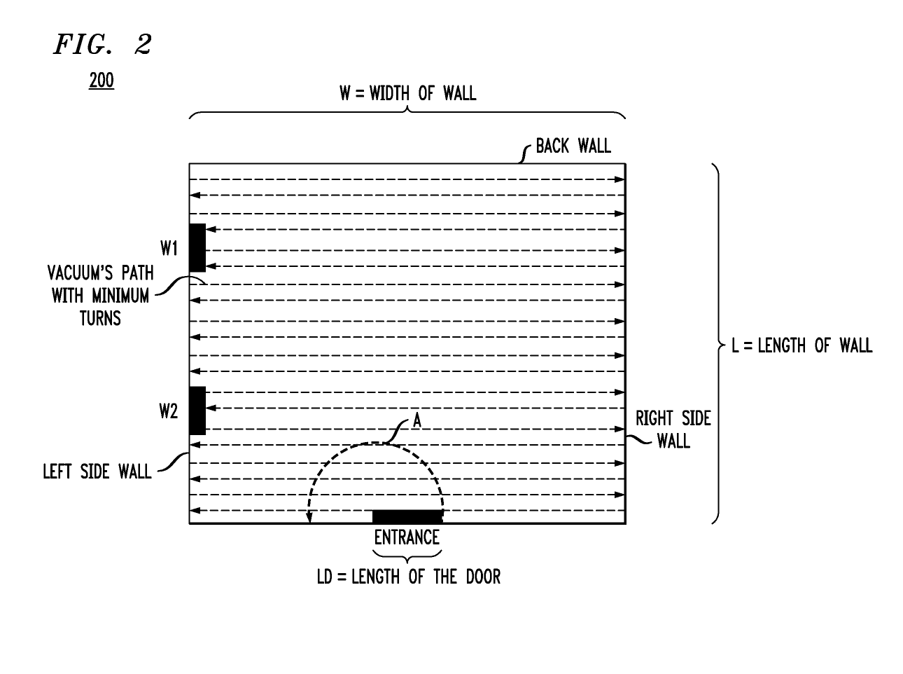

FIG. 2 illustrates the structure of a room and an optimal path for the movement of a cleaning device, according to an embodiment of the invention. Based on the idea that turns are time and energy consuming, the term optimal reflects a path that takes a minimum amount of turns by the vacuum cleaner to complete the task of vacuuming the room. Referring to FIG. 2, the room 200 includes left and right side walls having a length L, back and front walls having a width W, a first window W1, a second window W2, and an entrance door having a length LD. Indicated on FIG. 2 is the arc path A that the entrance door makes when opening.

FIG. 3 illustrates a first layout of items in the room, according to an embodiment of the invention. For example, FIG. 3 is an example of an initial layout of furniture in room 200. Included are a TV unit, three sofas (sofa 1, sofa 2 and sofa 3), and a table positioned proximate to the three sofas. The TV unit is placed against the wall on the right side of the room, opposite the wall on the left side of the room comprising windows W1 and W2. Sofa 3 is facing the TV unit. Sofa 1 is positioned a distance of “d” from the back wall.

By way of example, received requirements for determining an optimal layout include: 1) the distance of each sofa from each wall is at least “dw” (the initial position of sofa 1 at a distance of “d” from the back wall is less than dw, such that d<dw); 2) the television should be at a place where the effect of sunlight on the picture quality is minimized; 3) there should be enough space for occupants to move around in the room, and for children to play; and 4) the layout should permit the robot vacuum to move along an optimal path as previously described.

Taking into account the above requirements, the optimization component 110 develops an optimization model. Some of the optimal layouts proposed by the optimization component 110, satisfying the noted requirements and objectives of a user, are illustrated in FIGS. 4 and 5.

FIG. 4 illustrates a layout of items in the room, which is a first solution satisfying all the user defined requirements, as well as the global constraints mentioned above, according to an embodiment of the invention. To prevent sunlight from affecting the picture quality of the television, the TV unit is proposed to be moved from the right side wall to the left side wall, in between window W1 and window W2. Sofa 1 is proposed to be moved a distance of “dw” from the back wall, wherein “dw>d”, and sofa 3 is proposed to be moved closer to right side wall and turned around to face the TV unit. The entire grouping of furniture comprising sofa 1, sofa 2, sofa 3 and the table have been moved closer to the right side wall, leaving a large area between the grouping of the sofas and table and the TV unit to move around in the room and provide enough space for children to play.

FIG. 5 illustrates a layout of items in the room, which is a second solution satisfying all the user defined requirements, as well as the global constraints mentioned above, according to an embodiment of the invention. In this solution in FIG. 5, the grouping of furniture comprising the sofas and table have been moved closer to the TV unit than in FIG. 4, leaving a large space behind sofa 3 to move around in the room and provide enough space for children to play. Additionally, the grouping of furniture comprising the sofas and the table has been moved farther away from the back wall such that the distance of sofa 1 from the back wall exceeds dw.

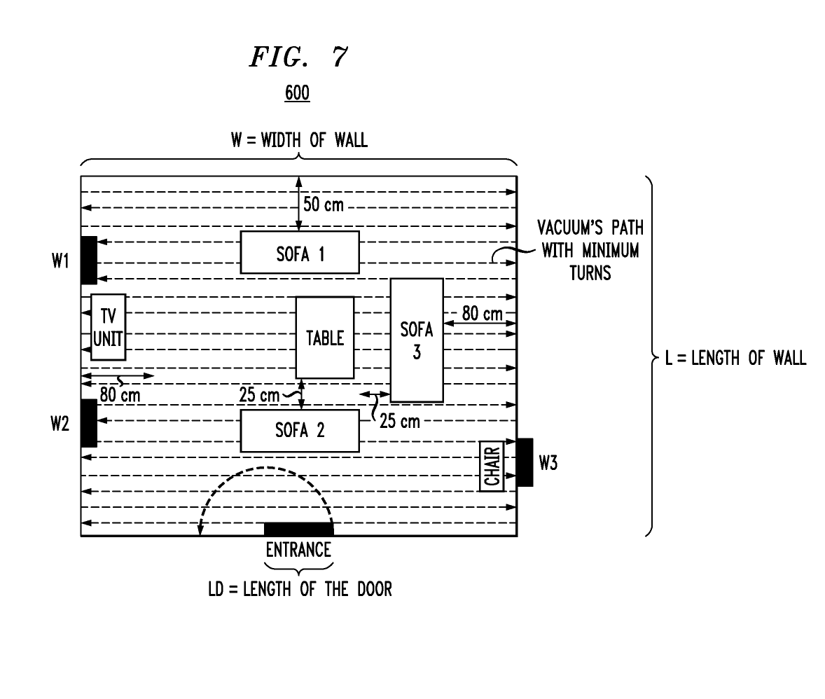

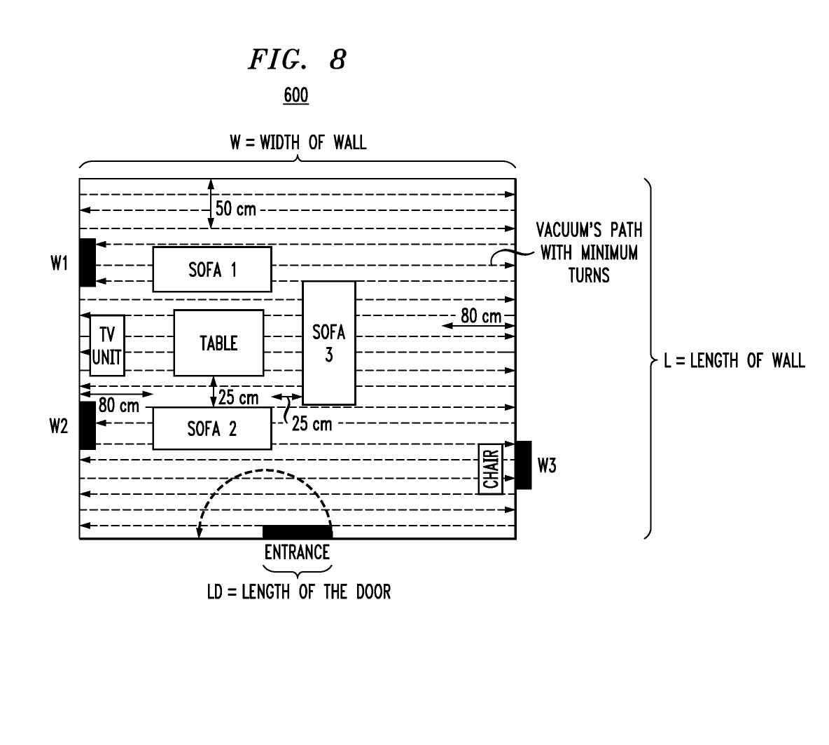

FIG. 6 illustrates an initial layout of a room 600, and FIGS. 7 and 8 illustrate resulting layouts according to embodiments of the invention, where a user enters parameters 102, constraints 104, and/or objectives 106 related to people sharing an environment, such as their age group, and specific movement requirements together with any other requirements. According to an embodiment of the present invention, the following illustrates examples of how a robot cleaning device 105 will receive different inputs from a user, and what will be the corresponding output. For example, a sample user input interface may include the following:

1) Is there a person at home that requires help with movement? User Input: Yes;

2) Does the person require a movement assistance device, such as a cane, walker, or similar device? User Input: Yes;

3) Does any person require more room to move around due to health conditions or personal preference/need? If yes please provide the number of people, age group, and the value of the following parameters for each:

a) User input: No. of people: 2

b) For first person the inputs are:
“Age group”: “Above 60 years”,
“minWidthReq”: “50 cm”
“minLinear Section”: “2 m”
“minTurningRadius”: “25 cm”

c) For second person the inputs are:
“Age group”: “Below 10 years”,
“minWidthReq”: “40 cm”
“minLinear Section” (straight pathway/walkways between furniture pieces): “3 m”
“minTurningRadius”: “30 cm”

4) Is there a required distance from windows, each wall, and entrance door? User Input: Yes

“minDistFromWindow”: “50 cm”,

“minDistFrom WallAgainst door”: “50 cm”,

“minDistFromWallLeftOfdoor”: “80 cm”,

“minDistFromWallRightOfdoor”: “80 cm”,

5) Does any person require a sitting place in sunlight in the room? If so, what type? User input: Yes—a chair

6) Does any person need some sitting arrangement with the windows in the room? User input: No

FIG. 6 illustrates an initial layout of room 600 prior to applying the above sample user inputs. A TV unit is positioned against a right side wall, opposite windows W1 and W2 on the left side wall. The furniture group comprising sofa 1, sofa 2, sofa 3 and the table are positioned close to the TV unit. A chair is positioned close to the left side wall, near window W1.

Corresponding to the above specific responses together with other global constraints such as, for example: “Television should not be against the sunlight”, “The door movement should not be interrupted by any object”, etc., the optimization component 110 may calculate and determine multiple optimal layouts. For example, the optimization component 110, and more specifically the model formulation engine 112 receives the initial layout of room 600, the above specific responses and the global constraints, and executes an optimization algorithm (e.g., a mixed integer or linear algorithm) and the determination module 114 determines the optimal layouts based on the results of the execution of the optimization algorithm.

According to an embodiment, the optimization component 110 via interface 116, will display all of the determined optimal layouts or a number of optimal layouts that the user chooses to be displayed, whichever is minimum. For example, a user may only input to see two optimal layouts, even though the optimization component 110 develops more than two optimal layouts. In this case, the optimization component 110 will provide what it determines to be the two most optimal layouts based on the received parameters 102, constraints 104, and/or objectives 106.

In accordance with a non-limiting embodiment of the present invention, a user is able to prioritize various objective constraints, and the system would be able to sort the layouts based on output values of the objective functions in the order of the user preference. For example, there may be multiple objective constraints with values from 0 to 10, with 10 being the highest and 0 being the lowest priority, as shown below:

Objective 1 =“Need more space for children: 10 out of 10”,

Objective 2 =“Need extra air flow: 8 out of 10”,

Objective 3 =“Chair needs to be near sunlight: 5 out of 10”, etc.

The system will rank the layout solutions based on the optimal value for Objective 1 (e.g., most open space) first, then Objective 2 (e.g., highest possible air flow with the most possible space, as found in first step for Objective 1) and so on.

Referring to FIG. 7, in a first optimal layout in connection with the above sample user inputs, the TV unit is moved to the left side wall, between windows W1 and W2. This prevents sunlight shining in through the windows from reducing the quality of the picture on the TV. The chair is moved from in front of window W1 to in front of window W3 on the right side wall. The furniture group comprising sofa 1, sofa 2, sofa 3 and the table are positioned closer to the right side wall leaving a large open area between the furniture group and the TV unit. Sofa 1 is positioned 50 cm from the back wall meeting the minimum width requirement for persons over 60 years old and children under 10 years old, and sofa 3 is positioned 80 cm from the right side wall meeting the minimum distance from the wall requirement. Sofas 1 and 2 are positioned 25 cm from sofa 3, and 25 cm from the table.

Referring to FIG. 8, in a second optimal layout in connection with the above sample user inputs, the TV unit and chair have been moved from their initial positions to the same position shown in the optimal layout illustrated in FIG. 7. However, the furniture group comprising sofa 1, sofa 2, sofa 3 and the table have been positioned close to the TV unit. Sofa 1 and sofa 2 are positioned 80 cm from the left side wall meeting the minimum distance from the wall requirement. Sofa 1 and sofa 2 are positioned 25 cm from sofa 3 and 25 cm from the table as illustrated in FIG. 8. Additionally, sofa 1 is positioned greater than 50 cm from the back wall in accordance with the minimum width requirement for persons over 60 years old and children under 10 years old.

In this example, a user may choose to select the first optimal layout illustrated in FIG. 7 over the second optimal layout illustrated in FIG. 8 if more area in front of the TV unit is preferred. On the other hand, the user may choose to select the second optimal layout if the user prefers to have more space on the back of the sofa which can be used, for example, as a children's play area or for placing a storage unit.

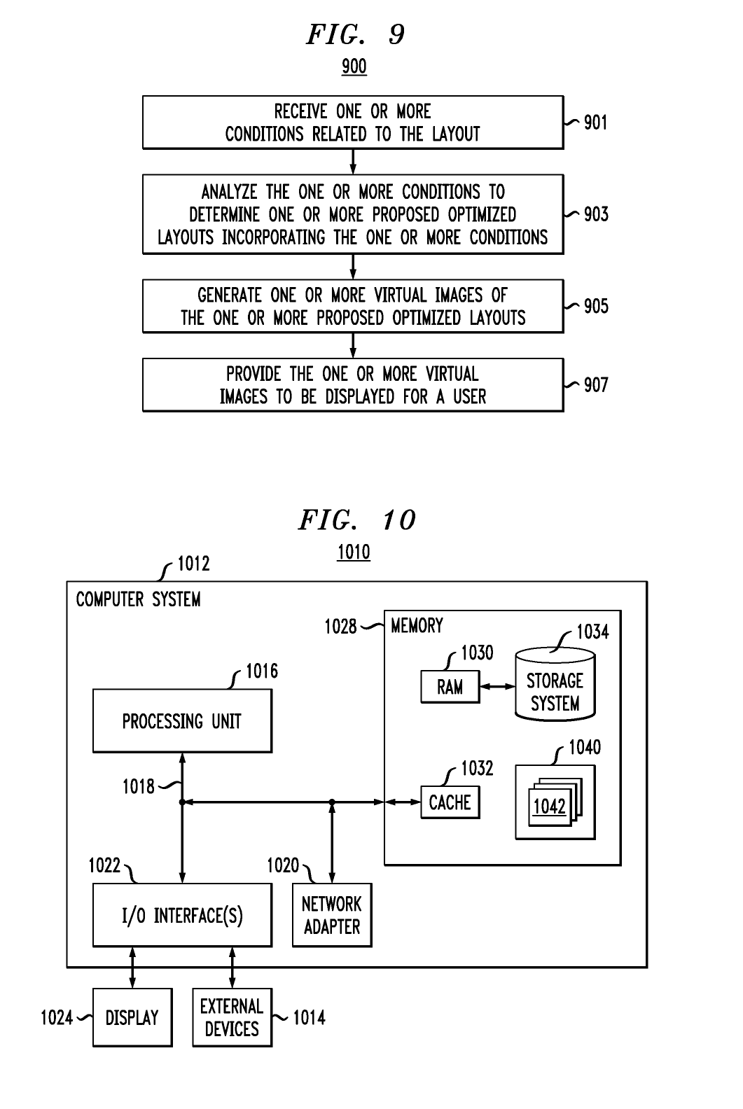

FIG. 9 is a flow diagram of a process for optimizing a layout of a plurality of items in a space, according to an exemplary embodiment of the invention. Referring to FIG. 9, the process 900 includes, at block 901, receiving one or more conditions related to the layout. For example, as noted herein, the conditions may include parameters, constraints and/or objectives, and the space can be a room in a residence/dwelling or some other structure, such as an office, factory, warehouse, store, etc.

According to an embodiment of the present invention, an objective can include creating a layout of the plurality of items in a space which results in an optimal path of a robot cleaning device through the space, wherein the optimal path takes a minimum amount of turns by the robot cleaning device to clean the space. The robot cleaning device can include, but is not necessarily limited to, a robot (e.g. automated) vacuum cleaner, and the optimal path can result in a minimum amount of turns by the vacuum cleaner to vacuum the space.

Another objective can include creating a layout of the plurality of items in the space which results in a reduction of a navigation hazard for an individual moving in the space. As used herein, a “navigation hazard” can refer to an issue with the configuration of items in a space that can lead to an individual or animal tripping, falling, colliding with or knocking over items, or having an otherwise obstructed path of movement that can potentially lead to injury when attempting to walk or otherwise move through the space.

Another objective can include creating a layout of the plurality of items in the space, which results in optimized airflow in the space. For example, a layout of items in a room can affect the flow of air, and may include obstacles, for example, objects adjacent or near a window or heating/cooling vents that restrict airflow through the room. Taking into account principles of airflow, embodiments of the present invention can be programmed to create layouts that optimize airflow for heating and cooling performance and/or for improved circulation of air throughout a space.

According to an embodiment of the present invention, a parameter can include, for example, a minimum distance required between a wall of the space and a piece of furniture in the space, a minimum distance required between at least two pieces of furniture in the space, and a minimum distance of a piece of furniture in the space from a window and/or door in the space.

According to an embodiment of the present invention, a constraint can include, for example, a requirement for a particular location of a piece of furniture in the space, such as, near a window, in direct sunlight (e.g., in the case of a plant), or out of sunlight (e.g., to prevent fading or deterioration), a requirement that at least two pieces of furniture be within a specified distance of each other (e.g., table and corresponding chairs of a dining set), and a requirement that a piece of furniture not be placed in a particular location of the space (e.g., restriction on placing items in front of a door, placing a television behind a sofa, etc.). Another constraint might include a requirement that electrical devices or appliances that need to be close to an outlet be placed within a specified distance from an outlet.

The method 900 further includes, at block 903, analyzing the one or more conditions to determine one or more proposed optimized layouts incorporating the one or more conditions. The analyzing may include executing a linear optimization and/or a mixed integer optimization algorithm, or other appropriate optimization algorithm based on the one or more conditions.

In accordance with an embodiment of the present invention, based, for example, on users' selections or predefined settings, a system is configured to generate a set of mathematical formulations for each of the objectives. For this purpose, the system can be configured to use a predetermined pool of mathematical formulations of all possible objectives allowed and request that users set a priority of the objectives. For purposes of explanation, this set of objective functions is referred to as OB1.

Defined constraints and/or parameters, for example, user defined constraints or parameters, as well as appropriate default constraints or parameters are then formulated into a set of mathematical requirements that the set of objective functions in OB1 need to satisfy.

In accordance with an embodiment of the present invention, the system will then rank the objective functions according to the defined priority. For example, if there are multiple objective functions and a user's priority is available, the system would sort the objective functions based on those user preferences.

Once a mathematical model, as well as the priority of the objective functions is ready, one or more optimization tools can be used to solve a mixed integer program or linear program. For example, “IBM® ILOG® CPLEX® Optimization Studio” is an example of an optimization tool that can be used to solve a mixed integer program.

In accordance with an embodiment of the present invention, generated optimal layouts and associated values for each objective function are ranked, choosing the best value for each objective function in order of predefined preferences, such as user preferences. The system can be configured to generate a list of the K most optimal layouts and present the K most optimal layout to a user as set forth in blocks 905 and 907.

The method 900 further includes, at block 905, generating one or more virtual images of the one or more proposed optimized layouts. For example, the virtual images can include virtual two-dimensional top views or three-dimensional views of a floor plan of the one or more proposed optimized layouts, as described in connection with FIGS. 4, 5, 7 and 8.

At block 907, one or more virtual images are provided, via, for example, an interface, to be displayed for a user. According to an embodiment, the virtual images can be electronically transmitted to a user device, such as, for example, a smart phone, tablet, personal computer (PC), or other device including a screen to display the virtual image of the room or other space having the optimized layout.

The method can also include ranking the one or more proposed optimized layouts, based, for example, on how many of the conditions are met by the layout, where the layouts meeting all or the most conditions are ranked higher than the layouts meeting less conditions. Two layouts meeting the same number of conditions may be further ranked based on other factors such as history of user preferences preferring one layout over another, or other factors, such as aesthetics, which can be learned over time, using, for example, machine learning techniques.

In addition or as an alternative to the methodologies described above, the system could also use a lexicographical ordering of objective values for ranking. For example, the system could be configured to generate strings of all possible values for the objective functions, where each value is concatenated to the next in order to generate a string. More specifically, assume three objective functions and three possible optimal layouts with values like below are generated:

S1: “2,4,5”

S2: “1,5,7”

S3: “9,4,6”,

where the first number denotes a value for Objective1, second number denotes a value for Objective 2 and so on.

Then, in accordance with an embodiment of the present invention, the system can be configured to rank according to the lexicographical order of those strings, as shown below:

S3: “9,4,6”

S1: “2,4,5”

S2: “1,5,7”.

As noted above, in order to obtain the initial layout of a space and identify its contents, the method may further include capturing a plurality of images of the space, and processing the plurality of images to generate a virtual model of the space. The processing can include extracting multiple rectilinear views from the images, and finding key-points between rectilinear views at multiple locations to relatively localize the views. A 3D point cloud model can be generated by applying, for example, SfM or SLAM imaging techniques.

The method can further include identifying each of the plurality of items in the space. The identification can be performed from the 3D point cloud by classifying point clusters to floors, walls and other objects by comparing the height of the points, and recognizing objects, such as, tables and chairs in the point clouds using 3D object recognition. Furthermore, coordinates of each of the plurality of items in the space, for example, top view 2D coordinates, can be extracted, the dimensions, for example, length, width and/or height of each of the plurality of items in the space can be calculated.

Embodiments of the present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

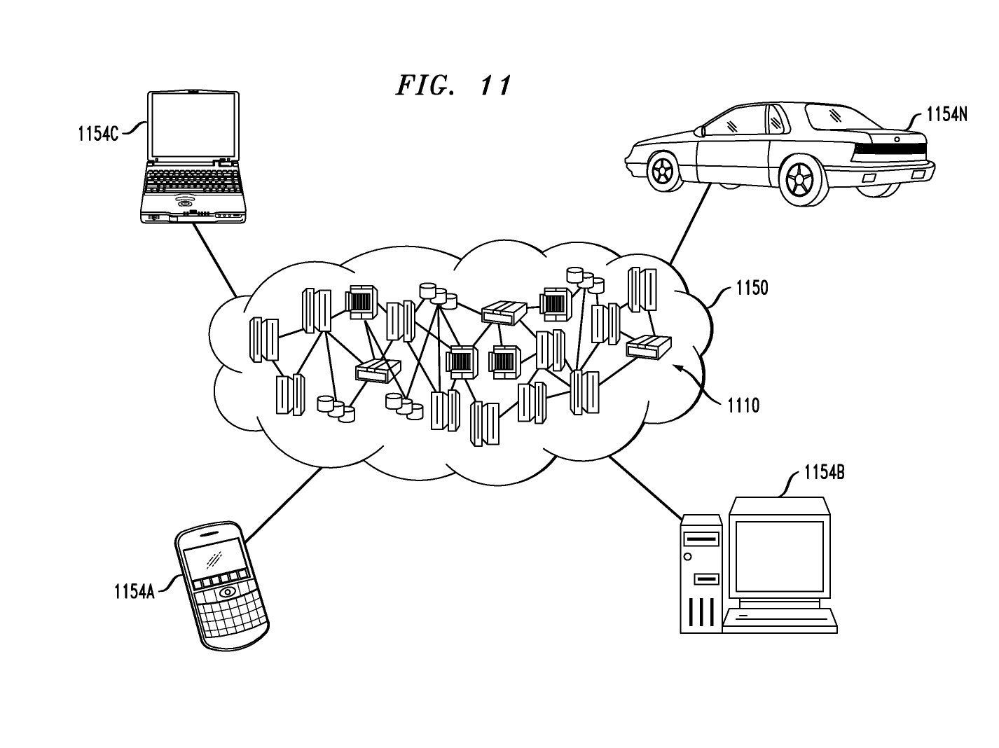

One or more embodiments can make use of software running on a general-purpose computer or workstation. With reference to FIG. 10, in a computing node 1010 there is a computer system/server 1012, which is operational with numerous other general purpose or special purpose computing system environments or configurations. Examples of well-known computing systems, environments, and/or configurations that may be suitable for use with computer system/server 1012 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 1012 may be described in the general context of computer system executable instructions, such as program modules, being executed by a computer system. Generally, program modules may include routines, programs, objects, components, logic, data structures, and so on that perform particular tasks or implement particular abstract data types. Computer system/server 1012 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 10, computer system/server 1012 in computing node 1010 is shown in the form of a general-purpose computing device. The components of computer system/server 1012 may include, but are not limited to, one or more processors or processing units 1016, a system memory 1028, and a bus 1018 that couples various system components including system memory 1028 to processor 1016.

The bus 1018 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The computer system/server 1012 typically includes a variety of computer system readable media. Such media may be any available media that is accessible by computer system/server 1012, and it includes both volatile and non-volatile media, removable and non-removable media.

The system memory 1028 can include computer system readable media in the form of volatile memory, such as random access memory (RAM) 1030 and/or cache memory 1032. The computer system/server 1012 may further include other removable/non-removable, volatile/nonvolatile computer system storage media. By way of example only, storage system 1034 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus 1018 by one or more data media interfaces. As depicted and described herein, the memory 1028 may include at least one program product having a set (e.g., at least one) of program modules that are configured to carry out the functions of embodiments of the invention. A program/utility 1040, having a set (at least one) of program modules 1042, may be stored in memory 1028 by way of example, and not limitation, as well as an operating system, one or more application programs, other program modules, and program data. Each of the operating system, one or more application programs, other program modules, and program data or some combination thereof, may include an implementation of a networking environment. Program modules 1042 generally carry out the functions and/or methodologies of embodiments of the invention as described herein.

Computer system/server 1012 may also communicate with one or more external devices 1014 such as a keyboard, a pointing device, a display 1024, etc., one or more devices that enable a user to interact with computer system/server 1012, and/or any devices (e.g., network card, modem, etc.) that enable computer system/server 1012 to communicate with one or more other computing devices. Such communication can occur via Input/Output (I/O) interfaces 1022. Still yet, computer system/server 1012 can communicate with one or more networks such as a local area network (LAN), a general wide area network (WAN), and/or a public network (e.g., the Internet) via network adapter 1020. As depicted, network adapter 1020 communicates with the other components of computer system/server 1012 via bus 1018. It should be understood that although not shown, other hardware and/or software components could be used in conjunction with computer system/server 1012. Examples, include, but are not limited to: microcode, device drivers, redundant processing units, external disk drive arrays, RAID systems, tape drives, and data archival storage systems, etc.

It is understood in advance that although this disclosure includes a detailed description on cloud computing below, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

Computing node 1010 in FIG. 10 can be an example of a cloud computing node. Computing node 1010 is only one example of a suitable cloud computing node and is not intended to suggest any limitation as to the scope of use or functionality of embodiments of the invention described herein. Regardless, computing node 1010 is capable of being implemented and/or performing any of the functionality set forth hereinabove. It is also to be understood that computing node 1010 is not necessarily a cloud computing node.

Referring now to FIG. 11, illustrative cloud computing environment 1150 is depicted. As shown, cloud computing environment 1150 comprises one or more cloud computing nodes 1110 with which local computing devices used by cloud consumers, such as, for example, a wearable device (not explicitly shown), a personal digital assistant (PDA) or cellular telephone 1154A, desktop computer 1154B, laptop computer 1154C, and/or automobile computer system 1154N may communicate. Nodes 1110 may communicate with one another. They may be grouped (not shown) physically or virtually, in one or more networks, such as Private, Community, Public, or Hybrid clouds as described hereinabove, or a combination thereof. This allows cloud computing environment 1150 to offer infrastructure, platforms and/or software as services for which a cloud consumer does not need to maintain resources on a local computing device. It is understood that the types of computing devices 1154A-N shown in FIG. 11 are intended to be illustrative only and that computing nodes 1110 and cloud computing environment 1150 can communicate with any type of computerized device over any type of network and/or network addressable connection (e.g., using a web browser).

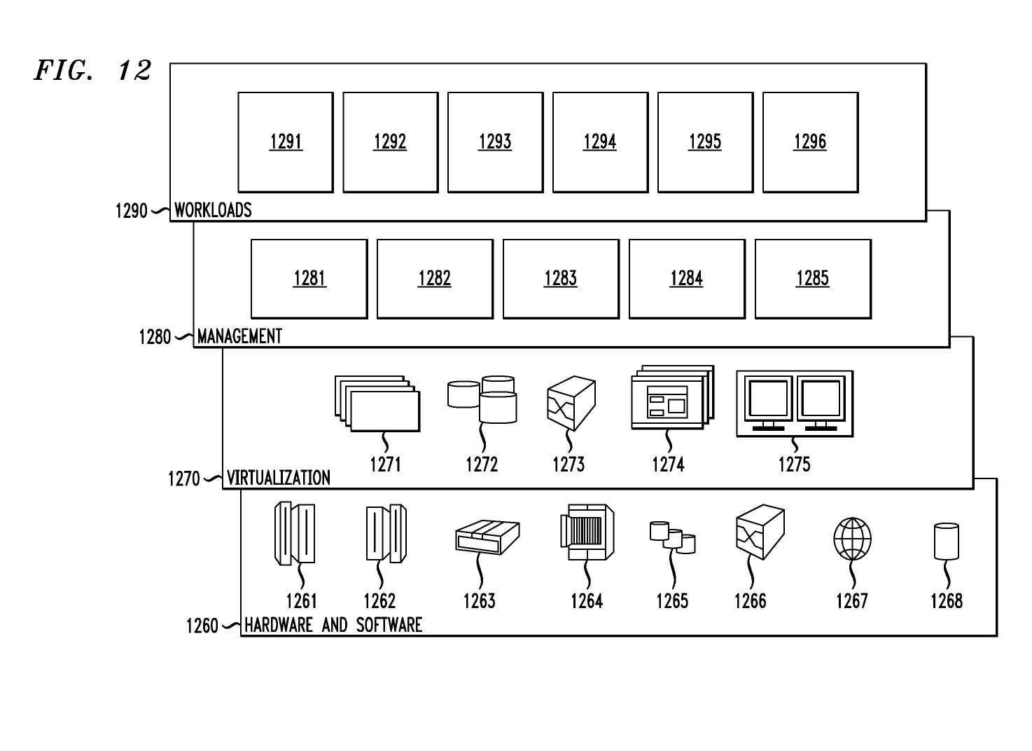

Referring now to FIG. 12, a set of functional abstraction layers provided by cloud computing environment 1150 (FIG. 11) is shown. It should be understood in advance that the components, layers, and functions shown in FIG. 12 are intended to be illustrative only and embodiments of the invention are not limited thereto. As depicted, the following layers and corresponding functions are provided:

Hardware and software layer 1260 includes hardware and software components. Examples of hardware components include: mainframes 1261; RISC (Reduced Instruction Set Computer) architecture based servers 1262; servers 1263; blade servers 1264; storage devices 1265; and networks and networking components 1266. In some embodiments, software components include network application server software 1267 and database software 1268.

Virtualization layer 1270 provides an abstraction layer from which the following examples of virtual entities may be provided: virtual servers 1271; virtual storage 1272; virtual networks 1273, including virtual private networks; virtual applications and operating systems 1274; and virtual clients 1275.

In one example, management layer 1280 may provide the functions described below. Resource provisioning 1281 provides dynamic procurement of computing resources and other resources that are utilized to perform tasks within the cloud computing environment. Metering and Pricing 1282 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 1283 provides access to the cloud computing environment for consumers and system administrators. Service level management 1284 provides cloud computing resource allocation and management such that required service levels are met. Service Level Agreement (SLA) planning and fulfillment 1285 provide pre-arrangement for, and procurement of, cloud computing resources for which a future requirement is anticipated in accordance with an SLA.

Workloads layer 1290 provides examples of functionality for which the cloud computing environment may be utilized. Examples of workloads and functions which may be provided from this layer include: mapping and navigation 1291; software development and lifecycle management 1292; virtual classroom education delivery 1293; data analytics processing 1294; transaction processing 1295; and optimal layout determination 1296, which may implement the functionality described above with respect to FIGS. 1-11.

Although illustrative embodiments have been described herein with reference to the accompanying drawings, it is to be understood that the invention is not limited to those precise embodiments, and that various other changes and modifications may be made by one skilled in the art without departing from the scope or spirit of the invention. For example, although largely discussed in the context of robot vacuum cleaners, the embodiments of the present invention are not necessarily limited thereto, the robot vacuum cleaner can be replaced with the other home appliances or devices equipped with different sensors, cameras, etc. such as smart-phones, tablets, laptop PCs, or video cameras in order to collect necessary data to create a 3D floor map. In this case, a user may need to walk around a room while a camera is recording, and rotate at various places to record images at multiple positions, and in multiple directions.

1. A method for optimizing a layout of a plurality of items in a space, comprising:
receiving one or more conditions related to the layout;
analyzing the one or more conditions to determine one or more proposed optimized layouts incorporating the one or more conditions;
generating one or more virtual images of the one or more proposed optimized layouts; and
providing the one or more virtual images to be displayed for a user;
wherein the method is performed by at least one computer system comprising at least one memory and at least one processor coupled to the memory.

2. The method according to claim 1, wherein the one or more conditions are selected from the group consisting of a parameter, a constraint and an objective.

3. The method according to claim 2, wherein the objective comprises creating the layout of the plurality of items in the space which results in an optimal path of a robot cleaning device through the space.

4. The method according to claim 3, wherein the optimal path takes a minimum amount of turns by the robot cleaning device to clean the space.

5. The method according to claim 4, wherein the robot cleaning device comprises a vacuum cleaner.

6. The method according to claim 2, wherein the objective comprises creating the layout of the plurality of items in the space which results in a reduction of a navigation hazard for an individual moving in the space.

7. The method according to claim 2, wherein the objective comprises creating the layout of the plurality of items in the space which results in optimized airflow in the space.

8. The method according to claim 2, wherein the parameter is selected from the group consisting of a minimum distance required between a wall of the space and a piece of furniture in the space, a minimum distance required between at least two pieces of furniture in the space, and a minimum distance of a piece of furniture in the space from at least one of a window and a door in the space.

9. The method according to claim 2, wherein the constraint is selected from the group consisting of a requirement for a particular location of a piece of furniture in the space, a requirement that at least two pieces of furniture be within a specified distance of each other, and a requirement that a piece of furniture not be placed in a particular location of the space.

10. The method according to claim 1, wherein the analyzing comprises executing at least one of a linear optimization and a mixed integer optimization algorithm based on the one or more conditions.

11. The method according to claim 10, wherein the one or more virtual images comprise at least one of virtual two-dimensional top views and virtual three-dimensional views of a floor plan of the one or more proposed optimized layouts.

12. The method according to claim 1, further comprising ranking the one or more proposed optimized layouts.

13. The method according to claim 1, further comprising:
capturing a plurality of images of the space;
processing the plurality of images to generate a virtual model of the space; and
identifying each of the plurality of items in the space.

14. The method according to claim 13, further comprising:
extracting coordinates of each of the plurality of items in the space; and
calculating dimensions of each of the plurality of items in the space.

15. A system for optimizing a layout of a plurality of items in a space, comprising:
a memory and at least one processor coupled to the memory, wherein the at least one processor is configured to:
receive one or more conditions related to the layout;
analyze the one or more conditions to determine one or more proposed optimized layouts incorporating the one or more conditions;
generate one or more virtual images of the one or more proposed optimized layouts; and
provide the one or more virtual images to be displayed for a user.

16. The system according to claim 15, wherein the one or more conditions comprise at least one objective, the at least one objective comprising creating the layout of the plurality of items in the space which results in an optimal path of a robot cleaning device through the space.

17. The system according to claim 15, wherein the one or more conditions comprise at least one parameter, the at least one parameter selected from the group consisting of a minimum distance required between a wall of the space and a piece of furniture in the space, a minimum distance required between at least two pieces of furniture in the space, and a minimum distance of a piece of furniture in the space from at least one of a window and a door in the space.

18. The system according to claim 15, wherein the one or more conditions comprise at least one constraint, the at least one constraint selected from the group consisting of a requirement for a particular location of a piece of furniture in the space, a requirement that at least two pieces of furniture be within a specified distance of each other, and a requirement that a piece of furniture not be placed in a particular location of the space.

19. The system according to claim 15, wherein, when analyzing the one or more conditions, the at least one processor is configured to execute at least one of a linear optimization and a mixed integer optimization algorithm based on the one or more conditions.

20. A computer program product for optimizing a layout of a plurality of items in a space, the computer program product comprising a computer readable storage medium having program instructions embodied therewith, the program instructions executable by a processor to cause the processor to perform a method comprising:
receiving one or more conditions related to the layout;
analyzing the one or more conditions to determine one or more proposed optimized layouts incorporating the one or more conditions;
generating one or more virtual images of the one or more proposed optimized layouts; and
providing the one or more virtual images to be displayed for a user.
